(19) United States
(12) Patent Application Publication
(10) Pub. No.: US 2017/0361523 A1
(43) Pub. Date: Dec. 21, 2017

(54) METHOD AND APPARATUS FOR PRODUCING A NANOSTRUCTURED OR MICROSTRUCTURED FOIL BY EXTRUSION COATING OR EXTRUSION CASTING

(71) Applicants: INMOLD A/S, Horsholm (DK); DANAPAK FLEXIBLES A/S, Slagelse (DE)

(72) Inventors: Henrik Pranov, Espergaerde (DK); Maria Matscjuk, Bagsvaerd (DK); Peter Johansen, Slagelse (DK); Ole Brodsgard, Slagelse (DK); Guggi Kofod, Kobenhavn N (DK)

(21) Appl. No.: 15/534,755

(22) PCT Filed: Dec. 10, 2015
(86) PCT No.: PCT/EP2015/079242

§ 371 Date: Jun. 9, 2017

(30) Foreign Application Priority Data
Dec. 10, 2014 (DK) PA 2014 00719

(51) Int. Cl. B29C 59/04; B29C 33/42; B29C 39/26; B29C 59/02; B29C 43/52; B29C 43/22; B29C 41/36; B29C 33/40; B29C 35/08

(52) U.S. Cl. CPC B29C 59/046; B29C 43/222; B29C 33/424; B29C 39/265; B29C 41/365; B29C 59/022; B29C 43/52; B29C 35/0888; B29C 33/405; B29C 2035/0827; B29C 2059/023

(57) ABSTRACT

A method for extrusion coating or extrusion casting, a polymer sheet (4, 5) produced thereby, a roller (2) for use in extrusion coating or extrusion casting, and an apparatus comprising said roller (2), in which micro- and/or nanostructures provided on the surface of the roller (2) are transferred to the polymer sheet (4, 5), and which is applicable to the extrusion coating or extrusion casting of all types of thermoplastic polymer.

### FIELD OF THE INVENTION

The present invention relates to a method and apparatus for manufacturing foils with a thermoplastic surface comprising micro- or nanostructures, preferably having a high aspect ratio.

### BACKGROUND OF THE INVENTION

In biotechnological, medical and consumer applications, it is desirable to apply functional structures e.g. micro- or nanostructures, to defined areas of articles for use as functional surfaces, altering the properties of the surface relative to that of an unstructured surface. Examples of desirable functions are optically active, self-cleaning or super repellent surfaces. A method of producing such articles independently of the overall macro-geometry is desirable, in particular if such articles are mass produced at a relatively low price or high productivity, as many of these articles must be disposable or low cost reusable products, e.g. toys or packaging material. Other desirable applications include optical functionality, such as anti-reflective foils for coating photo-voltaic elements to improve their efficiency, for windows to improve solar energy throughput, light diffusing foil for lighting and illumination applications, microlenses and microlens arrays for display applications. Moth-eye structures are known to combine self-cleaning and anti-reflective properties, which would be highly desirable as properties for solar energy applications. All of these functions derive their physical effect from accurate and detailed control of surface geometric designs and patterns with micro- and nanometer accuracy and resolution.

Lithography is a means of creating surface structures with high resolution and pattern control. In one approach that is commonly used for manufacture of central processing units (CPUs), a silicon wafer is provided with a homogeneous polymer coating known as the resist. The resist is overlaid by a mask having a predefined pattern. The mask is illuminated by ultraviolet (UV) light so only some parts of the resist are exposed. When the resist is subsequently rinsed with a solvent, parts of the resist will dissolve and other parts will remain. When the silicon wafer in this state is exposed to reactive ionized gas, material on the surface of the silicon wafer uncovered by resist will be removed, while material directly beneath the resist will remain unaffected. The remaining resist is now be removed by a different solvent to finally achieve a silicon wafer having a lithographically structured surface. This lithographic method for creating surface structures is versatile, capable of achieving sharply defined patterns with a lateral resolution below 20 nm.

The principles of the UV lithographic method can be varied tremendously, and are known in general simply as lithography:
The silicon wafer can be exchanged with any solid material substrate that can be etched, including metals, alloys, ceramics, glasses, polymers, composites, etc.
The resist can be sensitive to other types of exposure, including X-ray, electronic beam, laser light, laser holographic, etc.
Maskless methods exist which allow for direct writing of micro and nanostructures using for instance electron beams.
Direct imprint methods exist by which a mask having the desired surface structure in both lateral and vertical dimensions is pressed into the resist, thus transferring the structure with negative symmetry.

Structural features can be holes, pillars, lines, spirals, circles, ellipses, or other geometric or non-geometric shapes. The most commonly used method for making lithographically controlled micro or nanostructures in thermoplastic surfaces are variotherm injection molding type processes. By melting a thermoplastic material and injecting it into a mold under high pressure, the surface of the mold will be replicated, thereby generating a micro or nanostructured polymeric replica. The most common application of this is CD/DVD/Blu-Ray manufacturing, where a polymeric replica may be made in a few seconds. However, the molding of high aspect ratio structures, where the width is low and the depth is high, is challenging using these types of processes due to the rapid cooling of the melt surface upon injection into a mold held at a temperature below the solidification temperature of the polymer. One solution to this problem has been to vary the temperature of the mold during the process in a variotherm process where the mold is heated above the solidification temperature during melt injection and subsequently cooled below the solidification temperature in order to make the polymeric part solidify so it can be removed from the mold. This, however, increases the cycle time considerably.

Molds having lithographically controlled micro- and nanostructures on the polymer-shaping surfaces are commonly made from metal materials. The structure can be transferred to the mold surface using etching. A more specialized method includes blast imprinting. In a different approach, a thin metal shim can be inserted to cover part of the area of the mold. The metal shim is commonly a nickel plate which has been grown by electroplating from an original master structure that is prepared using any lithographic method. However, the nickel plate is not very durable and the micro- and nanostructures may be worn away during injection molding production. Also, not all polymers are effectively imprinted with micro- and nanostructures when using nickel shims. Embossing processes are closely related to the variotherm injection molding types of process, where a solid thermoplastic substrate, typically a foil, is being heated while in contact with a master structure made by conventional lithographic means. The master structure typically consists of a nickel or silicon or silicone (PDMS) shim or stamp. After heating and shaping of the surface topography of the substrate to be the inverse of the master structure, the master and substrate are cooled below the solidification temperature of the substrate, and the substrate may be removed. Typical processing throughputs of these types of processes are hundreds of cm² per heating/cooling cycle which typically takes from 10 s and up to several minutes depending on the apparatus, giving a productivity on the order of 10-100 cm²/s equaling 0.001-0.01 m²/s.

WO 2002058928 A1—“Polymer-inorganic particle composites” discloses inorganic particle/polymer composites that involve chemical bonding between the elements of the composite, and their use in various electrical, optical and electro-optical devices.

US 20130136818 A1—“Resin Mold for Nanoimprinting” discloses a mould having a resin layer in which fine depressions or protrusions are formed, in which the resin comprises a silicone or a fluorine based macromonomer and a polymerisable monomer selected from the group consisting of a (meth)acrylic monomer, a styrene-based monomer, an epoxy-based monomer, an olefin-based monomer and a polycarbonate-based monomer, wherein the mould has good release properties. The mould can be used as a stamper, which is pressed into a heated resin and held there until the resin cools to ensure transfer of the fine structure, or may be arranged on a roller, in which case the resin to which the structure is to be transferred must be UV-cured while it is in contact with the roller, with the UV light being shone through the roller to achieve this.

WO2007/126607—“Light redirecting film having surface nanonodules” discloses a light redirecting optical device comprising a polymeric film containing a light entry and a light exit surface and, bearing on the light exit surface, convex macrostructures that have a length, diameter or other major dimension of at least 25 micrometers, wherein a major portion of the macrostructure surface is covered with nano-nodules having an average maximum cord length in a plane perpendicular to the direction of light travel of less than 1200 nm. The macrostructures and nanonodules are applied to the film using a metallic roller, particularly one coated in chromium.

US2007/00013103—“Nanostructured article and means of making same” discloses a method of making a polymer film having a surface with nanofibrils. The nanofibrils are created by selective coating of release agent onto a porous metal tool so that, after filling the pores with molten polymer, peeling the polymer from the tool stretches the polymer that resides in the pores of the tool to result in nanofibrils having a length greater than the depth of the pores in the metal tool.

US2009/0087506—“Belt shaped mold and nanoimprint system using the belt shaped mold” discloses a belt shaped mold with which a fine structure having a high aspect ratio can be formed using nanoimprinting. The belt comprises a plurality of nickel stamper moulds.

EP2657004—“Method for manufacturing microscopic structural body” discloses a method for moulding a product in which a fine structure can be transferred to a thermoplastic molten polymer, using a stamper mould that is held in contact with the molten polymer for a holding time of around 20 s to ensure complete replication of the fine structure of the mould.

Some reports of high speed replication have been given, but only for low aspect ratio structures, typically decorative or diffractive structures.

For many applications these throughput rates are several orders of magnitude too slow. Applications such as functionalized foils for food packaging, or self-cleaning coatings of windows, ships or car windshields, all require throughputs on the order of 1 m²/s or higher in order to be economically feasible.

Due to the abovementioned problems with the state-of-the-art, it would be desirable to have a technological solution, where high aspect ratio micro or nanostructures may be formed in foils at low cost at high throughput rates. It would further be advantageous if this solution could provide micro or nanostructures of a high quality and it would be a further advantage if the micro or nanostructured area could cover the whole area of the manufactured foil.

To overcome the abovementioned problems of state-of-the-art an invention providing the technological solution with the abovementioned desired properties is here presented.

What we propose is to use an extrusion coating or casting type technology to coat or produce generic foils with a thin layer of a thermoplastic material, which is micro or nanostructured during the coating or casting process.

Extrusion coating is a process in which a carrier foil is moved between two rollers, a cooling roller and a counter roller, respectively. A polymeric melt is applied between the foil and the cooling roller in a continuous process. Upon contact with the cooling roller, the thermoplastic melt solidifies, and upon contact with the carrier foil, the thermoplastic melt is adhered to the carrier foil. The result is a carrier foil coated with a thin layer of a thermoplastic material.

Extrusion casting is a process in which a thermoplastic melt is moved between two rollers, a cooling roller and a counter roller, respectively. The thermoplastic melt is applied between the counter roller and the cooling roller in a continuous process. Upon contact with the cooling roller, the thermoplastic melt solidifies forming a thermoplastic foil. Extrusion casting is essentially the same process as extrusion coating, where the carrier foil is omitted, and extrusion coating will be descriptive to both the extrusion coating and the extrusion casting processes in this description, unless specifically stated.

We have invented a process that is able to produce micro or nanostructured thermoplastic coatings by micro or nanostructuring the cooling roller and by carefully choosing the extrusion coating process parameters. This process may enable production at high throughput rates. So far throughput rates of up to 0.5 m²/s, and subsequently up to 3.18 m²/s, have been demonstrated in pilot production setup, and using full scale production equipment, rates of 5-10 m²/s may be achieved. In order for the process to work, micro or nanostructured cooling rollers are required.

We have previously disclosed in WO2012/000500 the manufacture of micro- and/or nanostructured cooling rollers where the micro- and/or nanostructures are realized by embossing of a master structure in a hard and durable quartz coating on the surface of a stainless steel 316 roller. We have also shown in WO2015/144174 that it is possible to use a nickel shim for extrusion coating directly, by gluing it on the roller using double adhesive tape. A nickel shim that fully covers the entire roller surface can be made by electroplating from a large master mold. This shim can be fixed to the roller surface by various means, including adhesive tape and by use of screws.

However, it was found that when using nickel shims it was not possible to transfer nanostructures with high fidelity to every extrusion polymer. It was found that the common extrusion polymer polypropylene could replicate nanostructures for some production parameters of extrusion coating. Nanostructures could also be transferred when the ionomer resin Surlyn was used as extrusion polymer. It was then found that it was not possible to replicate nanostructures when using polystyrene as extrusion polymer, at any set of production parameters. These three polymers have different properties. Polypropylene is a semicrystalline material, which forms small domains of crystallites in an amorphous matrix when solidifying, a process which takes time and therefore allows the polymer to flow freely for relatively long periods of time during manufacture. Polystyrene is an amorphous material, which never forms crystallites, but becomes solid already at high temperatures, and therefore flows freely only for a very brief time. Surlyn is an ionomeric ethylene copolymer that has similar crystallization properties compared to polypropylene, which extends the time in which it flows freely. We recognized that the solidification properties of the extrusion polymer are the main factor affecting effective transfer of micro- and/or nanostructures in extrusion coating, and that it is desirable to find a method by which to extend the time in which the extrusion polymer flows freely.

We now disclose a method of micro- and/or nanostructuring polymer foils using extrusion coating and micro- and/or nanostructured cooling rollers, which works with all three types of polymer. The new method relies on the use of a polymer material for the micro- and/or nanostructured surface on the cooling roller. This reduces the heat conductivity of the surface of the cooling roller, such that the extrusion polymer maintains a higher temperature for longer time and therefore flows more freely for longer periods of time and makes possible or enhances the replication of the micro- and/or nanostructures on the cooling roller.

In particular, it was found that pieces of micro- and/or nanostructured non-thermoplastic polymer foil could be fixed with adhesive to the surface of the roller during extrusion coating, in which case it was found that the micro- and/or nanostructures were transferred with high fidelity when using polystyrene as the extrusion polymer. As mentioned, this was not possible using a nickel shim. Further, we found that the use of a particular mold material, FleFimo, produced by Soken Chemical & Engineering Company Ltd., Japan, gives excellent performance in extrusion coating, capable of accurately transferring micro- and/or nanostructures in the extrusion coating process to polypropylene, polystyrene and Surlyn.

We have shown that any type of non-thermoplastic polymer for surface nanostructures on the roller exhibits the feature of replicating nanostructures in any extrusion polymer. This includes previously produced nanostructured non-thermoplastic foil, which was placed on the cooling roller using adhesive tape and was capable of producing nanostructured foil by extrusion coating.

It is noted that nanostructured polymer surfaces can be manufactured via a range of methods, many of which are mentioned in NaPANIL Library of Processes Third edition with results of the NaPANIL-project, March 2012 (2014 revision and update), Publisher: Jouni Ahopelto, NaPANIL Consortium, Editor: Helmut Schift, Paul Scherrer Institut (PSI), Switzerland, ISBN: ISBN 978-3-00-038372-4. This includes thermal imprinting or embossing, in which a nanostructured master surface tool is pressed into the polymer surface. The fixation of the nanostructure in the polymer can take place by use of high forces; by heating the tool; by exposing a cross-linking polymer to heat, vapor, ultra-violet light, or other means of cross-linking; or by any other fixation method. Other methods of nanostructuring a polymer surface include the above mentioned lithographic methods, which lead to nanostructured polymer. All of these methods can be employed on the roller surface directly, or can be employed to create a foil, or to create a shim (metal or polymer, also known as a cliché) which can be fixed to the roller surface.

The present invention lies in the choice of the particular material in which the micro- or nanostructures are produced on the surface of the cooling roller for subsequent extrusion coating or casting. This material is now chosen to be a polymer, instead of the previously chosen metal or ceramic coatings. The choice of polymer materials for the surface micro- and/or nanostructured cooling roller extends the range of possible extrusion polymers. The invention is realized by the surprisingly high throughput and further enhanced surface quality of the process, as well as the ability of the process to make continuous areas of micro or nanostructures, including lithographically prepared structures, without significant seam lines and the ability to cover the whole area of the manufactured foil. Further, this approach simplifies the preparation of the cooling roller. Further, this approach expands the range of polymers that can be successfully imprinted with micro- or nanostructures during extrusion coating or casting.

### OBJECT OF THE INVENTION

It may be seen as an object of the present invention to provide an improved method for producing large areas of thermoplastic foil with a micro and/or nanostructured surface at a throughput rate larger than today's state-of-the-art, at a substantially lower cost than the cost associated with today's state-of-the-art processes, or with a substantially better quality of replication of the micro or nanostructures than state-of-the-art processes.

It is a further object of the invention to expand the possible range of extrusion polymers for micro- and nanostructuring in extrusion coating or casting.

It is a further object of the invention to enable production of spatially continuous micro or nanostructures without visible seam lines.

It is a further object of the present invention to provide an alternative to the prior art.

### DESCRIPTION OF THE INVENTION

The invention here presented relates to the process of manufacturing of a micro and/or nanostructured polymer coating applied onto carrier foils by the use of a micro and/or nanostructured roller. One embodiment of the technique is shown in FIG. 1. A carrier foil (1) is passed between the micro and/or nanostructured roller (2) and a counter roller (3). A thermoplastic melt is deposited between the micro and/or nanostructured roller (2) and the carrier foil (1). The micro and/or nanostructured roller (2) is kept at a temperature below the solidification temperature of thermoplastic melt. The micro and/or nanostructured roller (2) and the counter roller (3) rotate as indicated by the arrows, thereby moving the carrier foil (1) while laminating the thermoplastic melt (4) to the carrier foil (1). Suitably, the rotation of the rollers can be achieved by driving the rotation of one or both of the rollers, preferably the micro and/or nanostructured roller. Upon contact between the thermoplastic melt (4) and the micro and/or nanostructured roller (2), a simultaneous cooling and shaping of the thermoplastic melt (4) occurs, thereby forming a micro and/or nanostructured and solid thermoplastic coating which is laminated to the carrier foil, thereby forming a carrier foil comprising a micro and/or nanostructured thermoplastic coating (5). The rotational velocity of the rollers times the width of the foil equals the throughput of the process or the rate at which the micro and/or nanostructured surface is produced. Typical widths of rollers are from 10's of cm to several meters, and typical rotational velocities are from 10 to 300 meters/minute. The inventors have demonstrated successful production of both micro and nanostructured thermoplastic coatings with rotational velocities up to 60 m/min, on a roller 50 cm wide, resulting in a production rate of 30 m²/min or 0.5 m²/s, and production of micro and/or nanostructured thermoplastic coatings with rotational velocities of up to 3 m/s on a roller 1.06 m wide, resulting in a production rate of 3.18 m²/s. High aspect ratio structures, such as antireflective structures having a width of 250 nm and a height of 350 nm, thus an aspect ratio of 1.4, have been produced by this method.

Another embodiment is shown in FIG. 2. A thermoplastic melt (1) is is passed between the micro and/or nanostructured roller (2) and a counter roller (3). The micro and/or nanostructured roller (2) is kept at a temperature below the solidification temperature of thermoplastic melt (1). The micro and/or nanostructured roller (2) and the counter roller (3) rotate as indicated by the arrows, thereby moving and shaping the thermoplastic melt (1). Suitably, the rotation of the rollers can be achieved by driving the rotation of one or both of the rollers, preferably the micro and/or nanostructured roller. Upon contact between the thermoplastic melt (1) and the micro and/or nanostructured roller (2), a simultaneous cooling and shaping of the thermoplastic melt (1) occurs, thereby forming a micro and/or nanostructured and solid thermoplastic foil (4). The rotational velocity of the rollers times the width of the foil equals the throughput of the process or the rate of which micro and/or nanostructured surface is produced. Typical widths of rollers are from 10's of cm to several meters, and typical rotational velocities are from 10 to 300 meters/minute. The inventors have demonstrated successful production of micro and nanostructured thermoplastic foils with rotational velocities up to 60 m/min, on a roller 50 cm wide, resulting in a production rate of 30 m²/min or 0.5 m²/s, and production of micro and/or nanostructured thermoplastic coatings with rotational velocities of up to 3 m/s on a roller 1.06 m wide, resulting in a production rate of 3.18 m²/s. High aspect ratio structures, such as antireflective structures having a width of 250 nm and a height of 350 nm, thus an aspect ratio of 1.4, have been produced by this method.

The roller may be made by different techniques. A previously produced micro- and/or nanostructured non-thermoplastic polymer foil may be fixed to the roller surface by use of adhesives, or by use of any of the methods commonly employed in the printing industry. A separate metal or polymer shim may be produced, onto which the non-thermoplastic polymer micro and/or nanostructures are manufactured, followed by attaching the shim onto the roller for instance by screws or clamps or any of the methods commonly employed in the printing industry. The roller surface may have the non-thermoplastic polymer micro and/or nanostructures manufactured directly onto its surface.

The non-thermoplastic polymer micro and/or nanostructures for extrusion coating are made by different techniques. These may include extrusion coating, hot-embossing, thermal imprinting, lithography, or other methods. The polymer micro and/or nanostructures can also be made by coating the roller or shim with a resin which cures by exposure to ultra-violet light, imprinting this coating using a transparent stamp, then exposing the resin through the stamp using ultra-violet light to cure the resin into a hard material having the desired surface nanostructures.

The materials for non-thermoplastic polymer micro and/or nanostructures on the roller or shim are polymeric in nature. This is taken to also include materials that are composites of inorganic particles and polymer. The inorganic particles may have sizes ranging from 2 micrometers to 2 nm. The inorganic particles may have geometries ranging from spherical to elongated to flat. The inorganic particles may have a volume content in the composite of up to 66%. The material of the inorganic particles may comprise metal/metalloid particles, metal/metalloid oxides, metal/metalloid nitrides, metal/metalloid carbides, metal metalloid sulfides, metal/metalloid phosphates, or mixtures thereof. The inorganic particle surface may be covalently bonded with a compatibilization molecule agent containing an organic moiety, a siloxy moiety, a sulfide moiety, a sulphate moiety, a phosphate moiety, an amine moiety, a carboxyl moiety, a hydroxyl moiety, or a combination thereof.

The invention relates to a method for producing a micro and/or nanostructured thermoplastic polymer coating on a carrier foil comprising at least one nanostructured or microstructured surface area, said method comprising at least the following steps:
providing an extrusion coating roller for an industrial polymer extrusion coating process using an thermoplastic polymer;
applying a surface comprising a micro and/or nanostructured non-thermoplastic polymer foil or coating on the said extrusion coating roller, thereby forming a micro and/or nanostructured extrusion coating roller;
maintaining the temperature of the said micro and/or nanostructured extrusion coating roller below the solidification temperature, which for amorphous polymers is equivalent to the glass transition temperature, of the said thermoplastic polymer;
moving a carrier foil at a given velocity between the micro and/or nanostructured extrusion coating roller and a counter pressure roller by rotating the micro and/or nanostructured extrusion coating roller and/or the counter pressure roller at a given rotational velocity;
continuously applying a melt of said thermoplastic polymer between the said moving carrier foil and the said rotating micro and/or nanostructured extrusion roller, whereby said thermoplastic polymer melt is solidified upon contact with said micro and/or nanostructured extrusion coating roller maintained at a temperature below the solidification temperature, which for amorphous polymers is equivalent to the glass transition temperature, of the said thermoplastic polymer melt, thereby forming a solid micro- and/or nanostructured thermoplastic polymer coating on said carrier foil.

The invention furthermore relates to a method for producing a micro- and/or nanostructured thermoplastic polymer foil comprising at least one nanostructured or microstructured surface area, said method comprising at least the following steps:
providing an extrusion roller for an industrial polymer extrusion casting process using an thermoplastic polymer;
applying a surface comprising a micro and/or nanostructured non-thermoplastic polymer foil or coating on the said extrusion roller, thereby forming a micro and/or nanostructured extrusion roller;
maintaining the temperature of the said micro and/or nanostructured extrusion roller below the solidification temperature, which for amorphous polymers is equivalent to the glass transition temperature, of the said thermoplastic polymer;
continuously applying a melt of said thermoplastic polymer between the said micro and/or nanostructured extrusion roller and a counter pressure roller, wherein the micro and/or nanostructured roller and/or the counter pressure roller is rotated at a given rotational velocity, whereby said thermoplastic polymer melt is solidified upon contact with said micro and/or nanostructured extrusion roller maintained at a temperature below the solidification temperature of the said thermoplastic polymer melt, thereby forming a solid micro and/or nanostructured thermoplastic foil.

Preferably, the microstructures and/or nanostructures have a high aspect ratio. Preferably, the aspect ratio of the said nano or microstructure is more than 0.25, more preferably more than 0.5, more preferably above 0.75, more preferably above 1, more preferably above 1.5, and most preferably above 2.

Preferably, in the extrusion casting method of the invention, micro and/or nanostructures are produced on both sides of the cast foil by using both a micro and/or nanostructured extrusion roller and a micro and/or nanostructured counter roller.

Preferably, the said micro and/or nanostructured surface is applied by mounting micro and/or nanostructured shims on the said extrusion coating roller or extrusion roller.

Preferably, the high aspect ratio micro and/or nanostructured surface is applied by coating the said extrusion coating roller or extrusion roller with a material which is subsequently micro and/or nanostructured. Preferably, the said material is a polymer or polymer composite precursor which is micro and/or nanostructured by embossing to form a solid micro and/or nanostructured ceramic material and where said polymer or polymer composite precursor may be cured during embossing. Preferably, the said polymer composite materials for the said micro and/or nanostructures on the roller or shim:
comprises inorganic particles selected from the group consisting of metal/metalloid particles, metal/metalloid oxide particles, metal/metalloid nitride particles, metal/metalloid carbide particles, metal metalloid sulfide particles, metal/metalloid phosphate particles, or mixtures thereof; and/or
comprises inorganic particles having particle sizes with the largest feature having a size preferably below 2 micrometers, more preferably below 200 nm, even more preferably below 20 nm, most preferably having a size below 2 nm; and/or
comprises inorganic particles having geometries ranging from spherical to elongated to flat.

Preferably, the said polymer composite materials for the said micro and/or nanostructures on the roller or shim contain inorganic particles with a volume content of more than 0.1% by volume, preferably more than 0.25% by volume, even more preferably more than 1% by volume, even more preferably more than 5% by volume, even more preferably more than 20% by volume, and most preferably more than 50% by volume. Preferably, the said polymer composite materials for the said micro and/or nanostructures on the roller or shim contain inorganic particles having a covalently bonded compatibilization molecule agent containing an organic moiety, a siloxy moiety, a sulfide moiety, a sulphate moiety, a phosphate moiety, an amine moiety, a carboxyl moiety, a hydroxyl moiety, or a combination thereof.

Polymer composite materials are described in WO 2002058928.

Preferably, the said micro and/or nanostructures are provided as one or a plurality of foils that is glued to the surface of a roller or a shim using a thermoplastic or thermoset adhesive.

Preferably, the given rotational velocity at which the micro- and/or nanostructured roller and/or the counter roller rotates is at least 10 m/min, or 0.16 m/s, such as at least 0.5 m/s, such as at least 1 m/s, such as 3 m/s, 5 m/s or 10 m/s. Suitably the given rotational velocity has a range of from 0.16 m/s to 5 m/s, or from 5 m/s to 10 m/s.

The invention furthermore relates to a micro and/or nanostructured thermoplastic foil or a foil with a micro and/or nanostructured thermoplastic coating.

A micro or nanostructured foil is herein defined as an article, e.g., a packaging material, a decorative surface, a toy, a container or part of a container or a part of a medical device or a functional part of a medical device where the micro or nanostructure is intended to be able to change the surface properties of the material, non-limiting examples given; changing the hydrophilicity, molecular binding properties, sensing properties, drag properties, biological properties or facilitating biological process, the optical, reflective or diffractive properties, its tactile properties or holographic properties.

The present invention further provides a roller for extrusion coating or extrusion casting, comprising micro- and/or nanostructures on at least a part of its outer surface, wherein the micro- and/or nanostructures are formed from a non-thermoplastic polymer. Preferably, the roller is a cooling roller. Preferably, the micro- and or nanostructures are formed in a polymer sheet, which is affixed to the outer surface of the roller, or the micro- and/or nanostructures are formed as one or more polymer shims, which is/are affixed to the outer surface of the roller.

The present invention further provides an apparatus for extrusion coating or extrusion casting, comprising at least one roller according to the invention. Suitably, where the apparatus is for extrusion casting of thermoplastic polymer sheets having micro- and/or nanostructures on both sides of the sheet, the apparatus comprises two rollers according to the present invention, which need not be identical, arranged such that the thermoplastic polymer sheet is formed therebetween.

The present invention further provides the use of a roller or an apparatus according to the present invention for the shaping of a thermoplastic polymer.

By “carrier foil” is meant a thin substrate which is flexible and may be processed using roll-to-roll technologies. Non-limiting examples of foils are polymeric foils, cardboard foils or metal foils or foils comprised of more than one of these types, e.g. a metal-polymeric foil.

By “micro or nanostructured thermoplastic polymer coating” is meant a thin layer of a thermoplastic material that is applied to the carrier foil during the extrusion process, where the side not facing the carrier foil has a controlled micro or nanometer sized topography.

By “a micro or nanostructured surface” is meant a part of a surface containing controlled topographical micro or nanostructures.

By “extrusion coating” is meant the process of coating a foil in a continuous roll-to-roll process, as described in the literature, see e.g. Gregory, B. H., “Extrusion Coating”, Trafford, 2007, ISBN 978-1-4120-4072-3

By “extrusion coating roller” is meant the cooling roller contacting the melt in the extrusion coating process, thereby solidifying the melt, thereby transforming the melt into a solid.

By “extrusion roller” is meant the cooling roller contacting the melt in the extrusion casting process, thereby solidifying the melt, thereby transforming the melt into a solid.

By a “micro or nanostructured extrusion coating roller” is meant an extrusion coating roller containing controlled micro or nanostructures on at least part of the outer surface which are in contact with the thermoplastic melt during the extrusion coating process.

By a “micro or nanostructured extrusion roller” is meant an extrusion roller containing controlled micro or nanostructures on at least part of the outer surface which are in contact with the thermoplastic melt during the extrusion casting process.

By “controlled micro or nanostructures” is meant deterministic structures, fabricated with the intent of making structures with a given topography, length scale or other functional property. Typical methods for making controlled micro or nanostructures are lithographic methods, such as, but not limited to electron beam lithography, laser writing, deep ultraviolet stepping lithography, optical lithography, nano imprint lithography, self assembling lithography, embossing, colloid lithography, reactive ion etching, wet etching, metalization or other methods well known in the literature, see e.g. “Microlithography Fundamentals in Semiconductor Devices and Fabrication Technology” by Nonogaki et al, 1998 or “Microlithography: Science and Technology” by James R. Sheats and Bruce W. Smith, 1998 or “Principles Of Lithography, 3rd edition” by Harry J. Levinson, 2011.

By “spatially continuous” is meant an area which does not have any by eye visible seam lines.

By “seam line” is meant a line defect between two areas due to imperfect alignment of the said areas relative to each other.

By “solidification temperature” is meant the temperature at which a thermoplastic material is transformed from a liquid state to a solid state. For a description of thermoplastics and their behavior around the solidification temperature, see e.g. Tim Osswald and Juan P. Hernandez-Ortiz, Polymer Processing—Modeling and simulation, Munich [u.a.]: Hanser, 2006. If no well-defined solidification temperature exists for the material, the Vicat softening point may be used instead, see e.g. ASTM D1525-09 Standard Test Method for Vicat Softening Temperature of Plastics. Typically, the solidification temperature of commmercial thermoplastic polymers is in the range of from 70° C. to 170° C. For an amorphous polymer, the solidification temperature is the same as the glass transition temperature; for semicrystalline polymers, such as polypropylene, the solidification temperature is the highest temperature at which crystals can form, ie the crystallisation temperature, typically in the range of from 90° C. to 150° C., whereas the glass transition temperature is usually much lower (for example around −20° C. in the case of polypropylene).

By “counter pressure roller” is meant the roller exerting pressure on the carrier foil, the thermoplastic melt and the extrusion coating roller or extrusion roller in the extrusion process.

By “rotational velocity” is meant the velocity of the surface of a roller, which corresponds to the velocity of a foil in contact with the said roller under no-slip conditions.

By a “melt” is meant a thermoplastic material above its solidification temperature.

By a “solid thermoplastic” is meant a thermoplastic material below its solidification temperature.

By “shim” is meant an insert capable of being mounted on the extrusion roller or extrusion coating roller, typically comprising micro or nanostructures on its surface. These inserts typically consist of nickel or silicon, but may also consist of a polymer, in which case the polymer shim may be known as a cliché.

By “functionality” is meant a change in the material properties relative to a non-structured material. Non-limiting examples of functionalities that may be induced by micro or nanostructuring are: increased or decreased contact angle relative to a liquid, self cleaning properties, diffractive properties, improved welding properties, friction lowering or increasing properties, decreased reflective properties, food repellent properties, holographic properties, iridescent colors, structural colors, anti-fouling or anti-bacterial properties, identificational or information containing properties, biological functional properties, decorative or tactile properties.

By “identificational” is meant a recognizable topography, allowing an observer to conclude if the sample on which the identificational structure is placed is a genuine or a counterfeit product.

By “extrusion casting” is meant the process of solidifying a melt into a solid foil by moving the melt between two rotating rollers whose temperature is maintained below the solidification temperature of the melt, see e.g. “Plastics Extrusion Technology, 2nd edition” by Hensen, 1997.

By thermoplastic materials are meant polymeric materials capable of being melted and solidified by changing the temperature to be above or below the solidification temperature of the material, respectively. Usually, extrusion is performed with a melt temperature of up to 300° C., such as in the range of from 250 to 300° C. Non-limiting examples of thermoplastic polymers that may be used are acrylonitrile butadiene styrene (ABS), acrylic, celluloid, cellulose acetate, Ethylene-Vinyl Acetate (EVA), Ethylene vinyl alcohol (EVAL), Fluoroplastics, gelatin, Liquid Crystal Polymer (LCP), cyclic oleofin copolymer (COC), polyacetal, polyacrylate, polyacrylonitrile, polyamide, polyamide-imide (PAI), polyaryletherketone, polybutadiene, polybutylene, polybutylene therephthalate, polycaprolactone (PCL), polychlorotrifluoroethylene (PCTFE), polyethylene terephthalate (PET), polycyclohexylene dimethylene terephthalate (PCT), polycarbonate (PC), polyhydroxyalkanoates (PHAs), polyketone (PK), polyester, polyethylene (PE), polyetheretherketone (PEEK), polyetherimide (PEI), polyethersulfone (PES), Polyethylenechlorinates (PEC), polyimide (PI), polylactic acid (PLA), Polymethylpentene (PMP), polyphenylene oxide (PPO), polyphenylene sulfide (PPS), polyphthalamide (PPA), polypropylene (PP), polystyrene (PS), polysulfone (PSU), polyurethane (PU), polyvinyl acetate (PVA), polyvinyl chloride (PVC), polyvinylidene chloride (PVDC) and styrene-acrylonitrile (SAN), a polymer matrix substance for a medical drug, or mixes or copolymers thereof.

Non-thermoplastic polymers suitable for forming a micro and/or nanostructured layer on the extrusion roller or extrusion coating roller are preferably selected from the group of classes of polymer consisting of: UV curable polymers, heat curable polymers, rubbers and chemically reactive polymers. It will be appreciated that the polymer for forming a micro and/or nanostructured layer on the extrusion roller or extrusion coating roller must be stable to the temperatures imposed upon it during the extrusion process, and in particular must not soften, melt, distort or become adherent when in contact with the thermoplastic polymer melt. The skilled person is able to select suitable polymers for use with specific thermoplastic polymers to be extruded, having regard to the temperature of the melt and of the structured roller, amongst other process conditions, and these suitable polymers we refer to herein as “non-thermoplastic polymers” as they do not soften, melt, distort or become adherent under the conditions used in a given extrusion process with a particular thermoplastic polymer melt. Suitably, the non-thermoplastic polymer will not melt on heating, but instead will decompose without melting, typically at high temperatures, such as in the range of from 350° C. to 450° C. depending on the availability of oxygen during heating. Examples of suitable non-thermoplastic polymers include Norland adhesive, which is UV curable; heat curable imprint polymers; UV curable resists. It should be noted that only the external structured surface of the roller need be non-thermoplastic, and thus the micro- and/or nanostructured roller may comprise a coating that comprises a thermoplastic foil coated with a non-thermoplastic layer, such as a UV curable polymer. Thus, a non-thermoplastic polymer foil suitable for use in the coating of the micro- and/or nanostructured roller includes here any polymer foil where the outermost surface of the foil, as mounted on the roller, ie the surface which contacts the molten polymer during the extrusion coating or casting process, consists of a non-thermoplastic polymer, but other layers (if any) can be other than non-thermoplastic polymer.

In some embodiments the micro or nanostructure comprises controlled micro or nanostructures made by lithographic or holographic means with a characteristic minimum feature size of less than 1 μm.

All of the features described may be used in combination so far as they are not incompatible therewith.

### BRIEF DESCRIPTION OF THE FIGURES

FIG. 1 shows a schematic diagram of an extrusion coating apparatus and process

FIG. 2 shows a schematic diagram of an extrusion casting apparatus and process

FIG. 3 shows a flow chart of a method for making the micro or nanostructured foil.

### DETAILED DESCRIPTION

The method and apparatus according to the invention will now be described in more detail with regard to the accompanying figures. The figures show one way of implementing the present invention and are not to be construed as being limiting to other possible embodiments falling within the scope of the attached claim set.

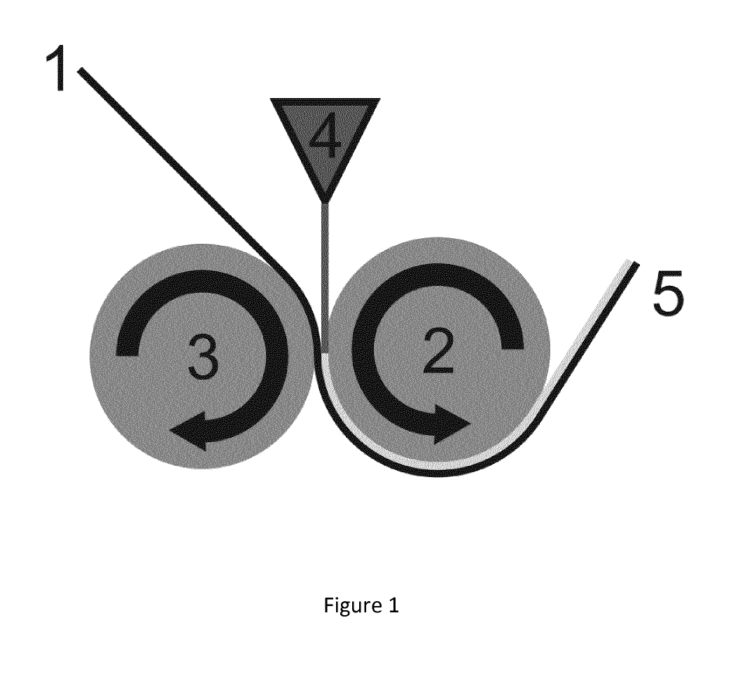

FIG. 1 shows one embodiment of the technique. A carrier foil (1) is passed between the micro or nanostructured roller (2) and a counter roller (3). An amorphous or semicrystalline thermoplastic melt is deposited between the micro or nanostructured roller (2) and the carrier foil (1). The micro or nanostructured roller is kept at a temperature below the solidification temperature of said amorphous or semicrystalline thermoplastic melt. The micro or nanostructured roller and the counter roller rotate as indicated by the arrows, thereby moving the carrier foil while laminating the thermoplastic melt to the carrier foil. Upon contact between the amorphous or semicrystalline thermoplastic melt (4) and the micro or nanostructured roller (2), a simultaneous cooling and shaping of the amorphous or semicrystalline thermoplastic melt occurs, thereby forming a micro or nanostructured and solid amorphous or semicrystalline thermoplastic coating which is laminated to the carrier foil, thereby forming a carrier foil comprising a micro or nanostructured amorphous or semicrystalline thermoplastic coating. The cooling times using a polymeric structure on said extrusion roller are much longer relative to a metal-coated nanostructured extrusion cooling roller, hence improving replication quality significantly (5).

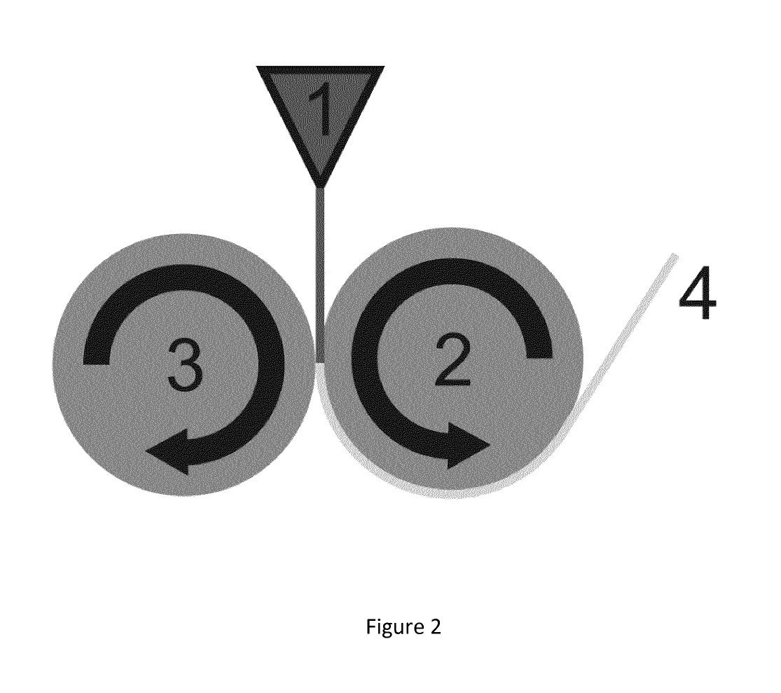

FIG. 2 shows another embodiment of the technique. An amorphous or semicrystalline thermoplastic melt is (1) is passed between the micro or nanostructured extrusion roller (2) and a counter roller (3). The micro or nanostructured roller is kept at a temperature below the solidification temperature of the amorphous or semicrystalline thermoplastic melt. The micro or nanostructured roller and the counter roller rotate as indicated by the arrows, thereby moving and shaping the amorphous or semicrystalline thermoplastic melt. Upon contact between the amorphous or semicrystalline thermoplastic melt (1) and the micro or nanostructured roller (2), a simultaneous cooling and shaping of the amorphous or semicrystalline thermoplastic melt occurs, thereby forming a micro or nanostructured and solid thermoplastic foil (4).

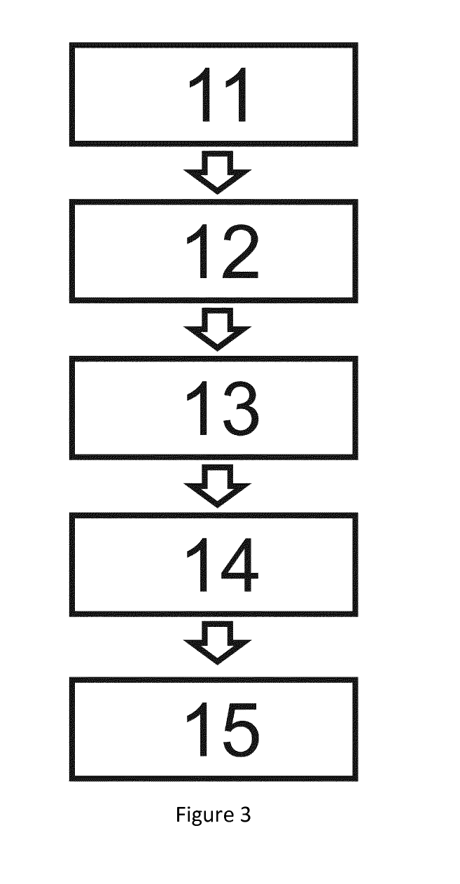

FIG. 3 shows a flow chart of a method for making the micro or nanostructured foil. First an initial extrusion coating roller for an industrial polymer extrusion coating process using an amorphous or semicrystalline thermoplastic material is provided (11), then a micro or nanostructured surface on the said extrusion coating roller is applied (12) thereby forming a micro or nanostructured extrusion coating roller (13) which is maintained at a the temperature below the solidification temperature of the said amorphous or semicrystalline thermoplastic material. A carrier foil is placed between the rotating micro or nanostructured extrusion coating roller and a rotating counter pressure roller, thereby being moved at a given velocity corresponding to the rotational velocity of the rotating micro or nanostructured extrusion coating roller (14). By continuously applying a melt of said amorphous or semicrystalline thermoplastic material between the said moving carrier foil and the said rotating micro or nanostructured extrusion roller, the said amorphous or semicrystalline thermoplastic melt is solidified after contact with said micro or nanostructured extrusion coating roller maintained at a temperature below the solidification temperature of the said amorphous or semicrystalline thermoplastic melt thereby forming a solid micro or nanostructured amorphous or semicrystalline thermoplastic coating on said carrier foil (15).

### Detailed Description of an Embodiment

In a first example a ø300 mm, 600 mm wide extrusion roller was mounted with 100 μm thin PET polymer foil with a diffraction grating topography. A polyethylene melt was extrusion coated onto a PET carrier foil at a velocity of 30 m/min, resulting in the production of a foil covered with diffraction gratings defined in the polyethylene coating laminated to the PET carrier foil.

In a second example a 0300 mm, 600 mm wide extrusion roller is coated with a 2 μm layer of Norland Adhesive grade NOA 63, which is structured by step-and-repeat embossing and ultra-violet exposure of a self cleaning nanostructure on a PDMS stamp that is transparent or semi-transparent to ultra-violet light. The nanostructured adhesive coating on the roller is used for the extrusion coating process. A stretchable laminate foil with a hotmelt backing is used as carrier foil and a polypropylene thermoplastic melt is applied to the carrier foil at 60 m/min. Thereby 0.6 m²/s of self cleaning foil is produced. The produced foil is laminated to transport vehicles in order to make them self cleaning.

In a third example a 850 mm long, 600 mm wide sheet of stainless steel having a thickness of 0.4 mm was coated with a 2 μm layer of heat curable imprint polymer grade mr-I 9000M from micro resist technology GmbH, which was structured by step-and-repeat embossing and flash heating of a nickel shim having a microlens array microstructure. The microstructured polymer coating on the roller was used for the extrusion coating process. A stretchable laminate foil with a hotmelt backing was used as carrier foil and a polystyrene thermoplastic melt was applied to the carrier foil at 60 m/min. Thereby 0.6 m²/s of microlens array foil with excellent optical transmission was produced. The produced foil can be used in optical sensors to focus the incoming light onto the light-sensitive parts of the sensor array.

In a fourth example a 01000 mm, 2500 mm wide piece of non-thermoplastic polymer foil having an inverse drag reduction microstructure is fixed to the surface of a suitable extrusion roller by use of a suitable adhesive. The microstructured roller is used for the extrusion coating process. A stretchable laminate foil with a hotmelt backing is used as carrier foil and a polypropylene thermoplastic melt is applied to the carrier foil at 60 m/min. Thereby 0.6 m²/s of drag reduction foil is produced. The foil is laminated to cover a ship hull, thereby reducing the drag on the ship, and hence reducing CO2 emissions or increasing the top speed.

In a fifth example 01000 mm, 2500 mm wide extrusion roller is coated with a 2 μm layer of UV-curable resist grade mr-UVCur06 from micro resist technology GmbH, which is structured by step-and-repeat embossing and ultra-violet light exposure of a yoghurt repellent microstructure on a PDMS stamp which has been coated with an anti-adhesive promoter. The nanostructured roller is used for the extrusion coating process. A cardboard foil is used as carrier foil and a polypropylene thermoplastic melt is applied to the carrier foil at 200 m/min. Thereby 5 m²/s of food repellent cardboard foil is produced, which is used for yoghurt packaging, ensuring that the yoghurt packaging may be completely emptied, thereby reducing food waste.

In a sixth example 8 identical pieces of non-thermoplastic polymer micro-Fresnel foil having a size of 800 mm by 1250 mm were fixed to a steel sheet having a size of 3200 mm by 2500 mm in a fully covering pattern using a suitable adhesive. The micro-Fresnel structure was characterized by having parallel lines of triangular wedges where one side is perpendicular to the surface plane and has a depth of 40 μm and a pitch between the lines of 300 μm. The foil sheet was used as a cliché, ie a polymer shim, on a suitable steel roller and fixed to the said roller using methods common in the printing industry. The micro-Fresnel structured roller was used for the extrusion coating process. A previously produced foil having an anti-reflective structure was used as carrier foil, such that the unstructured side was towards the melt, and a transparent and ageing resistant thermoplastic melt was applied to the carrier foil at 20 m/min. The side of the foil having the micro-Fresnel structures was coated using Aluminium metal sputtering, after which the Aluminium layer is extrusion coated with a protection layer. Thereby 50 m²/min of solar concentrating foil was produced, which can be used for concentrating solar light for a heating application, to produce central heating for district heating in a city and off-setting the need for fossil fuels.

In a seventh example a stainless steel sheet is prepared with holes and fixtures similar to a shim for a flexo-print printing press. The sheet having a size of 3100 mm long and 2500 mm wide and a thickness of 0.3 mm is spray-coated with a 1 μm layer of ultra-violet curable imprint resist by mixing it with a suitable solvent. The resist is structured by step-and-repeat embossing and ultra-violet exposure by use of a transparent PDMS stamp having an optically varying diffractive pattern in the shape and design of a company logo. The step-and-repeat pattern is hexagonal. The steel sheet is mounted directly on the suitable cooling roller and is used for the extrusion coating process. A pre-metallized laminate foil with a hotmelt backing is used as carrier foil and a Surlyn ionomer thermoplastic melt is applied to the carrier foil at 100 m/min. Thereby 250 m²/min of packaging foil with bright optically varying logos on the one side is produced without the need for inks or pigments. The foil is used for anti-counterfeit protection of pharmaceutical tablets in a blister-pack.

In an eighth example a Poly-acrylo-nitrile (PAN) melt is blown extruded at 240 C with cooling roller and counter roller maintained at 70 C. The cooling roller comprises a non-thermoplastic polymer coating having decorative structures thereon, and has a width of 1.5 m. A 20 μm thin PAN-foil comprising decorative structures is produced at a rate of 0.5 m/s, giving a productivity of 0.75 m²/s of decorative foil used for plastic bags.

In a ninth example a 30 μm thick polystyrene (PS) foil is extrusion cast between a pair of rollers having thereon a nanostructured non-thermoplastic polymer coating, resulting in a PS foil with structures on both sides. The rollers comprise cell active structures, resulting in a PS foil comprising structures which have a biological activity. The PS foil is corona treated in line, and cut out in small, hexagonal pieces with a dimension of 30 μm*100 μm*100 μm. The hexagonal pieces are then used as micro beads in adherent cell proliferation reactors with the main purpose of inducing a more natural cell behavior and the secondary purpose of vastly increasing the available surface area for the cells.

Further aspects of the invention are set out in the following clauses:
1. A method for producing a nanostructured amorphous thermoplastic polymer coating on a carrier foil comprising at least one nanostructured or microstructured surface area, said method comprising at least the following steps:
   providing an initial extrusion coating roller for an industrial polymer extrusion coating process using an amorphous thermoplastic material
   applying a surface comprising a nanostructured non-thermoplastic polymer foil or coating on the said extrusion coating roller, thereby forming a nanostructured extrusion coating roller
   maintaining the temperature of the said nanostructured extrusion coating roller below the glass transition temperature of the said amorphous thermoplastic material
   moving a carrier foil between the rotating nanostructured extrusion coating roller and a rotating counter pressure roller at a given velocity corresponding to the rotational velocity of the rotating high aspect ratio nanostructured extrusion coating roller
   continuously applying a melt of said amorphous thermoplastic material between the said moving carrier foil and the said rotating nanostructured extrusion roller, whereby said amorphous thermoplastic melt is solidified upon contact with said nanostructured extrusion coating roller maintained at a temperature below the glass transition temperature of the said amorphous thermoplastic melt thereby forming a solid nanostructured amorphous thermoplastic coating on said carrier foil.
2. A method for producing a nanostructured amorphous thermoplastic polymer coating on a carrier foil comprising at least one nanostructured or microstructured surface area, said method comprising at least the following steps:
   providing an initial extrusion coating roller for an industrial polymer extrusion coating process using an amorphous thermoplastic material
   applying a surface comprising a nanostructured non-thermoplastic polymer foil or coating on the said extrusion coating roller, thereby forming a nanostructured extrusion coating roller
   maintaining the temperature of the said nanostructured extrusion coating roller below the glass transition temperature of the said amorphous thermoplastic material
   continuously applying a melt of said amorphous thermoplastic material between the said counter roller and the said rotating high aspect ratio nanostructured extrusion roller, whereby said amorphous thermoplastic melt is solidified upon contact with said high aspect ratio nanostructured extrusion roller maintained at a temperature below the solidification temperature of the said amorphous thermoplastic melt thereby forming a solid high aspect ratio nanostructured thermoplastic foil.
3. A method according to clause 1 or 2, where the aspect ratio of the said nano or microstructure is above 2, more preferably above 1.5, more preferably above 1, more preferably above 0.75, even more preferably above 0.5, and most preferable more than 0.25.
4. A method according to any previous clause, where high aspect ratio nanostructures are produced on both sides of the cast foil by using both a high aspect ratio nanostructured extrusion roller and a high aspect ratio nanostructured counter roller.
5. A method according to any previous clause where the said high aspect ratio nanostructured surface is applied by mounting high aspect ratio nanostructured shims on the said initial extrusion coating roller.
6. A method according to any previous clause where the high aspect ratio nanostructured surface is applied by coating the said initial extrusion coating roller with a material which is subsequently high aspect ratio nanostructured.
7. A method according to clause 6 where the said material is a polymer or polymer composite precursor which is nanostructured by embossing to form a solid high aspect ratio nanostructured ceramic material and where said polymer or polymer composite precursor may be cured during embossing.
8. A method according to any of the previous clauses where the said polymer composite materials for the said high aspect ratio nanostructures on the roller or shim
   comprising inorganic metal/metalloid particles, metal/metalloid oxides, metal/metalloid nitrides, metal/metalloid carbides, metal metalloid sulfides, metal/metalloid phosphates, or mixtures thereof
   having particle sizes with the largest feature having a size preferably below 2 micrometers, more preferably below 200 nm, even more preferably below 20 nm, most preferably having a size below 2 nm
   having geometries ranging from spherical to elongated to flat.
9. A method according to any of the previous clauses where the said polymer composite materials for the said high aspect ratio nanostructures on the roller or shim contain inorganic particles with a volume content of more than 0.1% by volume, preferably more than 0.25% by volume, even more preferably more than 1% by volume, even more preferably more than 5% by volume, even more preferably more than 20% by volume, and most preferably more than 50% by volume.
10. A method according to any of the previous clauses where the said polymer composite materials for the said high aspect ratio nanostructures on the roller or shim contain inorganic particles having a covalently bonded compatibilization molecule agent containing an organic moiety, a siloxy moiety, a sulfide moiety, a sulphate moiety, a phosphate moiety, an amine moiety, a carboxyl moiety, a hydroxyl moiety, or a combination thereof.
11. A method according to any of the previous clauses where the said high aspect ratio nanostructures are provided as one or a plurality of foils that is glued to the surface of a roller or a shim using a thermoplastic or thermoset adhesive
12. An amorphous thermoplastic foil according to clause 2 or a foil with a high aspect ratio nanostructured amorphous thermoplastic coating according to clause 1 made by any of the previous clauses.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

All patent and non-patent references cited in the present application are also hereby incorporated by reference in their entirety.

1-20. (canceled)

21. A method for producing a microstructured thermoplastic polymer coating on a carrier foil, the coating comprising at least one microstructured surface area, said method comprising:
providing an extrusion coating roller for an industrial polymer extrusion coating process using a thermoplastic polymer;
applying a surface comprising a microstructured non-thermoplastic polymer foil on the said extrusion coating roller, thereby forming a microstructured extrusion coating roller;
maintaining the temperature of the said microstructured extrusion coating roller below the solidification temperature of the said thermoplastic polymer;
moving the carrier foil at a fixed velocity between the microstructured extrusion coating roller and a counter pressure roller by rotating the microstructured extrusion coating roller at a fixed rotational velocity; and
continuously applying a melt of said thermoplastic polymer between the said moving carrier foil and the said rotating microstructured extrusion coating roller, whereby said thermoplastic polymer melt is solidified upon contact with said microstructured extrusion coating roller maintained at a temperature below the solidification temperature of the said thermoplastic polymer melt thereby forming a solid microstructured thermoplastic polymer coating on said carrier foil.

22. The method according to claim 21, wherein microstructures are produced on both sides of the carrier foil by using both the microstructured extrusion coating roller and a microstructured counter pressure roller.

23. The method according to claim 21, wherein an aspect ratio of the said microstructures is more than 0.25.

24. The method according to claim 21, wherein the said microstructured surface is applied by mounting microstructured shims on the said extrusion coating roller.

25. The method according to claim 21, wherein the microstructured surface is applied by coating the said extrusion coating roller with a material which is subsequently microstructured.

26. The method according to claim 25, wherein the said material is a polymer composite precursor which is microstructured by embossing to form a solid microstructured polymer composite material, and wherein said polymer composite precursor may be cured during embossing.

27. The method according to claim 26, wherein the said polymer composite materials for the said microstructures on the roller:
comprise inorganic particles selected from the group consisting of:
metal/metalloid particles, metal/metalloid oxide particles, metal/metalloid nitride particles, metal/metalloid carbide particles, metal metalloid sulfide particles, metal/metalloid phosphate particles, or mixtures thereof; and/or
comprise inorganic particles having particle sizes with a largest feature having a size preferably below 2 micrometers.

28. The method according to claim 25, wherein the said polymer composite materials for the said microstructures on the roller contain inorganic particles with a volume content of more than 0.1% by volume.

29. The method according to claim 25, wherein the said polymer composite materials for the said microstructures on the roller contain inorganic particles having a covalently bonded compatibilization molecule agent containing an organic moiety, a siloxy moiety, a sulfide moiety, a sulphate moiety, a phosphate moiety, an amine moiety, a carboxyl moiety, a hydroxyl moiety, or a combination thereof.

30. The method according to claim 21, wherein the said microstructured non-thermoplastic polymer foil on the said extrusion coating roller is provided as at least one foil that is glued to the surface of a roller using a thermoplastic.

31. The method according to claim 21, wherein the fixed rotational velocity at which the microstructured extrusion coating roller rotates is at least 10 m/min.

32. A method for producing a microstructured amorphous thermoplastic polymer foil comprising at least one microstructured surface area, said method comprising:
providing an extrusion roller for an industrial polymer extrusion casting process using a thermoplastic polymer;
applying a surface comprising a microstructured non-thermoplastic polymer foil or coating on the said extrusion roller, thereby forming a microstructured extrusion roller;
maintaining the temperature of the said microstructured extrusion roller below the solidification temperature of the said thermoplastic polymer; and
continuously applying a melt of said thermoplastic polymer between the said microstructured extrusion roller and a counter pressure roller, wherein the microstructured extrusion roller is rotated at a fixed rotational velocity, whereby said thermoplastic polymer melt is solidified upon contact with said microstructured extrusion roller maintained at a temperature below the solidification temperature of the said thermoplastic polymer melt, thereby forming a solid microstructured thermoplastic polymer foil.

33. A microstructured thermoplastic foil made according to the method of claim 32.

34. A roller for extrusion coating or extrusion casting, comprising microstructures on at least a part of its outer surface, wherein the microstructures are formed from a non-thermoplastic polymer.

35. The roller according to claim 34, the roller being a cooling roller.

36. The roller according to claim 34, wherein the microstructures are formed in a polymer sheet, the polymer sheet being affixed to the outer surface of the roller.

37. The roller according to claim 34, wherein the microstructures are formed as at least one polymer shim, the at least one polymer shim being affixed to the outer surface of the roller.

38. An apparatus for extrusion coating, comprising at least one roller according to claim 34.

39. An apparatus for extrusion casting of thermoplastic polymer sheets having microstructures on both sides of the sheet, comprising two rollers according to claim 34, wherein the two rollers are arranged such that the thermoplastic polymer sheet is formed therebetween.
